(19) United States
(12) Patent Application Publication
(10) Pub. No.: US 2011/0069596 A1
(43) Pub. Date: Mar. 24, 2011

(54) HOLOGRAPHIC RECORDING METHOD, A HOLOGRAPHIC RECORDING MEDIUM AND USE OF SUCH MEDIUM

(76) Inventors: Suzanne Martin, Dublin (IE); Dennis Bade, Dublin (IE); Izabela Naydenova, Dublin (IE); Vincent Toal, Dublin (IE)

(21) Appl. No.: 12/736,812

(22) PCT Filed: May 14, 2009
(86) PCT No.: PCT/IE2009/000025

§ 371 Date: Nov. 12, 2010

(30) Foreign Application Priority Data
May 14, 2008 (IE) 2008/0378
Sep. 16, 2008 (IE) 2008/0747

(51) Int. Cl. G11B 7/00; G11B 7/26

(52) U.S. Cl. 369/103; 369/272.1; G9B/7; G9B/7.194

(57) ABSTRACT

A method of recording content comprising the steps of: providing a content storage medium comprising a pre-recorded grating or hologram; and illuminating a pre-recorded grating or hologram with a single recording beam to record content in the grating or hologram. The recording beam may increase the diffraction efficiency of the pre-recorded grating or hologram. Alternatively, the recording beam may form a new grating or hologram in close proximity to a pre-recorded grating or hologram.

The invention relates to an improved method for recording data content and images in a holographic storage system; the invention also relates to a storage system and to a visual hologram.

In holographic data storage systems the storage of data, either in bit or page format, involves the recording of a grating or hologram and this means the use of two coherent laser beams, the splitting and manipulation of which makes the optical head bulky and complex (Lambertus Hesselink, Sergie S. Orlov, Matthew C. Bashaw “Holographic data storage systems” Proc IEEE, Vol 92 (8), pp 1231-1280 (2004)). With any optical system that involves a high spatial frequency interference pattern, simplicity and compactness are of particular importance because sub-micron mechanical stability is needed in both arms of the interferometer in order to maintain a stable interference pattern. Holographic data storage systems depend on the recording of such interference patterns into a recording medium. Efforts are constantly being made to simplify and improve the stability of recording set-ups. The simplest to date would appear to be the collinear approach published by Optware (“Ecma international creates TC44 to standardise holographic information storage systems”, http://www.optware.co.jp/english/PR_TC44_{—}26_Jan_{—}05.html) where two beams are combined before reaching the recording medium, but the optical head is quite complex.

There is therefore a need for a simplified recording system.

### STATEMENTS OF INVENTION

According to the invention there is provided a method of recording content comprising the steps of:
providing a content storage medium comprising a pre-recorded grating or hologram; and
illuminating the pre-recorded grating or hologram with a single recording beam to record content in the content storage medium.

The recording beam may increase the diffraction efficiency of the pre-recorded grating or hologram. The recording beam may increase the diffraction efficiency of the pre-recorded grating or hologram by at least 40 fold. The recording beam may increase the diffraction efficiency of the pre-recorded grating by at least 100 fold.

The single recording beam may be an on-Bragg beam (the beam may be at the same Bragg angle of the pre-recorded grating or hologram). Alternatively, the single recording beam may be off-Bragg (the beam may be at a slight angle to the Bragg angle of the pre-recorded grating). In a further embodiment, the single recording beam may be within the Bragg envelope. Multiple gratings or holograms may be recorded using the same pre-recorded grating by varying the off-Bragg angle of the recording beam during content recording.

The recording beam may form a new grating in close proximity to the illuminated pre-recorded grating or hologram. The single beam may be an off-Bragg beam. The single beam may be within the Bragg envelope of the pre-recorded grating. Multiple gratings or holograms may be recorded using the same pre-recorded grating by varying the off-Bragg angle of the recording beam during content recording.

The content storage medium may comprise a self developing holographic recording medium. The pre-recorded grating or hologram may be recorded in the self developing holographic recording medium. The pre-recorded grating or hologram may by recorded in the self developing holographic recording medium using two recording beams. The pre-recorded grating or hologram may have a spatial frequency of up to 7,000 lines per mm such as up to 6,300 lines per mm. The pre-recorded grating or hologram may have a spatial frequency of between 2,500 to 6,300 lines per mm. The pre-recorded grating or holographic may have a spatial frequency of between 1,000 to 2,500 lines per mm, such as 500 to 1,000 lines per mm, for example 100 to 500 lines per atm or 1 to 100 lines per mm.

The content storage medium may comprise a plurality of pre-recorded gratings or holograms.

The invention further provides for the use of a self developing holographic recording medium containing a pre-recorded grating or hologram for the storage of content.

We also describe the use of a self developing holographic recording medium containing a pre-recorded grating or hologram for the storage (recording) of visually read images and text.

The content may be data (text) or an image. The content may be visible by eye.

Content may be stored by enhancing the pre-recorded grating or hologram, for example the diffraction efficiency of the pre-recorded grating or hologram may be increased by illumination with a single beam. The single beam may be an on-Bragg beam. Alternatively the single beam may be an off-Bragg beam for example a single beam within the Bragg envelope of the pre-recorded grating.

Alternatively, content may be stored by forming a new grating in close proximity to a pre-recorded grating or hologram; for example the new grating may be formed by illumination of the pre-recorded grating with a single beam at a slight angle to the Bragg angle of the pre-recorded grating (an off-Bragg beam). The single beam may be in the Bragg envelope of the pre-recorded grating.

The recording medium may have a thickness of between 1 μm and 1 mm. The recording medium may comprise a plurality of pre-recorded gratings or holograms. The pre-recorded gratings or holograms may be multiplexed. The pre-recorded holograms or gratings may be multiplexed in the medium. The pre-recorded grating or hologram may comprise a reflection grating or hologram. Alternatively, the pre-recorded grating or hologram may comprise a transmission grating or hologram. In one embodiment, the pre-recorded grating or hologram may comprise a combination of a reflection and transmission gratings and holograms.

The holographic recording medium may be write once, read many times. The holographic recording medium may contain a security hologram.

The invention further provides for a content storage medium comprising a self developing holographic recording medium containing a pre-recorded grating or hologram. The invention also provides for a holographic recording medium comprising a self developing holographic recording medium containing a pre-recorded grating or hologram. The invention further still provides for a security hologram comprising a self developing holographic recording medium containing a pre-recorded grating or hologram. The security hologram may be visible by eye.

The recording medium may have a thickness of between 0.1 μm and 5 mm, such as a thickness of between 0.1 μm and 2.5 mm, for example a thickness of between 0.1 μm and 1 mm. The recording medium may contain a plurality of pre-recorded gratings or holograms. The pre-recorded gratings or holograms may be multiplexed, for example the pre-recorded holograms or gratings may be multiplexed in the medium. The pre-recorded grating or hologram may comprise a reflection grating or hologram. Alternatively, the pre-recorded grating or hologram may comprise a transmission grating or hologram. In one embodiment the recording medium may comprise a combination of reflection and transmission gratings or holograms.

The content storage medium may be write once, read many times. The content storage medium may contain a security hologram.

It will be understood that the term “content” as used herein includes data such as textual data and alpha numerical data; images such as graphical images, videos, video clips, photographs, audio recordings, barcodes and the like.

It will be understood that the term “on-Bragg” as used herein means a beam that is at the same Bragg angle as one of the beams used to record the pre-recorded grating or hologram. It will be understood that the term “off-Bragg” as used herein means a beam that is at a different angle to that of either of the beams used to record the pre-recorded grating or hologram. It will be understood that the term “Bragg envelope” as used herein means the range of angles within which a single beam can be successfully used to record a grating of enhanced diffraction efficiency by exploiting an existing low efficiency pre-recorded grating.

It will be understood that the term “close proximity” as used herein means that the new grating or hologram is formed within the Bragg envelope of the pre-recorded grating or hologram.

We also describe the use of a self developing holographic recording medium containing a pre-recorded grating or hologram for the storage of data. Data may be stored by enhancing the pre-recorded grating or hologram, for example the diffraction efficiency of the pre-recorded grating or hologram may be increased by illumination with a single beam. The recording medium may have a thickness of between 1 μm and 1 mm. The recording medium may comprise a plurality of pre-recorded gratings or holograms. The recorded gratings or holograms may be multiplexed. The holograms or gratings may be multiplexed in the medium. The pre-recorded grating or hologram may comprise a reflection grating or hologram. The pre-recorded grating or hologram may comprise a transmission grating or hologram. The pre-recorded grating or hologram may comprise a combination of a reflection and transmission gratings and holograms. The holographic recording medium may be write once, read many times. The holographic recording medium may contain a security hologram.

We also describe a data storage medium comprising a self developing holographic recording medium containing a pre-recorded grating or hologram. The recording medium may have a thickness of between 0.1 μm and 5 mm, such as a thickness of between 0.1 μm and 2.5 mm, for example a thickness of between 0.1 μm and 1 mm. The recording medium may contain a plurality of pre-recorded gratings or holograms. The pre-recorded gratings or holograms may be multiplexed, for example the pre-recorded holograms or gratings may be multiplexed in the medium. The grating or hologram may comprise a reflection grating or hologram. The grating or hologram may comprise a transmission grating or hologram. The grating or hologram may comprise a combination of a reflection and transmission gratings or holograms. The data storage medium may be write once, read many times. The data storage medium may contain a security hologram.

We also describe a method of recording data comprising the steps of:
providing a data storage medium comprising a pre-recorded grating or hologram; and
illuminating the pre-recorded grating or hologram with a single recording beam to record data in the grating or hologram.
   wherein the recording beam increases the diffraction efficiency of the pre-recorded grating or hologram by at least 40 fold. The recording beam may increase the diffraction efficiency of the pre-recorded grating by at least 100 fold. The data storage medium may comprise a self developing holographic recording medium. The pre-recorded grating or hologram may be recorded in the self developing holographic recording medium. The pre-recorded grating or hologram may by recorded in the self developing holographic recording medium using two recording beams. The pre-recorded grating or hologram may have a spatial frequency of up to 7,000 lines per mm such as up to 6,300 lines per mm. The pre-recorded grating or hologram may have a spatial frequency of between 2,500 to 6,300 lines per mm. The pre-recorded grating or holographic may have a spatial frequency of between 1,000 to 2,500 lines per mm, such as 500 to 1,000 lines per mm, for example 100 to 500 lines per mm or 1 to 100 lines per mm. The data storage medium may comprise a plurality of pre-recorded gratings of holograms. The single recording beam may be an on-Bragg beam. The single recording beam may be off-Bragg. The single recording beam may be within the Bragg envelope.

One of the advantages of the system described herein over current systems is that the two beam holographic recording, requiring extreme stability of the optical system, is done at the point of production of the content storage medium, not at the point when the content is ‘written” by the end user, therefore content storage can be implemented without the need for a complicated on-the-spot holographic recording system. In addition, despite the simplicity of the single beam content recording head, the full range of angular multiplexing is still possible, as is transmission or reflection format or a combination of both.

Although there will be some reduction in the dynamic range for use of the single beam content recording technique in comparison to a regular two beam recording, the increased dynamic range available due to the large thickness of the gratings is expected to compensate for the reduction in the dynamic range of the single beam recording.

Currently, in holographic data storage systems, storage of data either in bit or page format involves the recording of a grating or hologram involving the use of two coherent laser beams, the splitting and manipulation of which makes the optical head bulky and complex. Our approach, which allows simple one beam recording, with angular multiplexing, would be a significant advance. The content storage techniques described herein could be used for Write Once Read Many mass memory devices, or, in a simpler version, to enable a section or sections of a security hologram to be individually writable. In the content storage application one of the benefits of the approach described herein is the simplicity and cost saving associated with the optical head (content writing). The techniques described herein allow for the use of low cost low coherence light sources and enable recording in desktop environments without stabilization. These advantages could allow the developing technology to sidestep many of the problems that have hindered its introduction into the marketplace.

In the security hologram application we describe a technology for which there is no equivalent that we know of on the market. This has potential uses in passports, security cards, biodata recording, individualization of security holograms (inclusion of barcodes, serial numbers, personal data etc. within the hologram) and encryption.

In an additional embodiment of the invention, the pre-recorded grating or hologram may be used to simplify the mass production of holograms. The pre-recorded grating or hologram is first recorded with a laser having a suitable coherence length for holographic recording, in a mechanically stable environment using a very short exposure and then either the diffraction efficiency of a pre-recorded grating or hologram is increased or a new grating or hologram is formed in close proximity to a pre-recorded grating or hologram under single beam exposure using low coherence light sources in unstable conditions. The reduced need for a mechanically stable, high coherence environment results in a significant cost reduction and time saving in the production of high volumes in applications such as security holography and holograms for packaging.

It will be appreciated that the applications described herein can be combined in various different combinations.

### BRIEF DESCRIPTION OF THE DRAWINGS

The invention will be more clearly understood from the following description of an embodiment thereof, given by way of example only, with reference to the accompanying drawings, in which:

FIG. 1 is a schematic of a system using the single beam grating enhancement concept for (bit wise) Holographic Data Storage (HDS) recording. (A) illustrates a writing step in a holographic storage ‘disk’ where pre-recorded gratings are ‘enhanced’ with a single beam; and (B) illustrates a reading step in a holographic storage ‘disc’ where higher diffraction efficiency is obtained from ‘enhanced’ gratings;

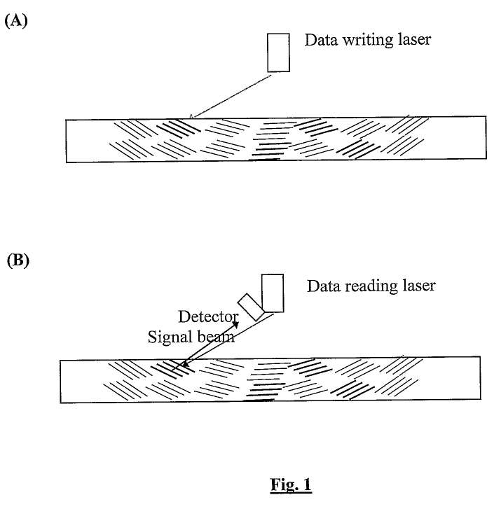

FIGS. 2 A and B are graphs showing the typical increase in diffraction efficiency with time when a weak (<2%) grating is exposed to a single on-Bragg beam. A standard 2 s two-beam recording of a grating is followed by a 25 s delay, and then single beam exposure starts at 27 s. The diffraction efficiency is observed to increase by more than an order of magnitude;

FIG. 3 is a graph showing the growth of the diffracted beam intensity under single beam exposure conditions for sample layers of different thicknesses;

FIG. 4 is a graph showing Bragg curves (the variation of diffraction efficiency with reading beam angle of incidence) for a series of gratings formed using the single beam process using different angles of incidence of the single writing beam. The gratings were recorded in different photopolymer layers, but are shown here on one graph for comparison purposes. The arrows indicate the offset (in degrees) from the Bragg angle of the seed grating (0°). There are two identical recordings at each angle. The thickness is 130 microns and the spatial frequency is 500 lines/mm;

FIG. 5 is a graph showing that an individual grating from a series of gratings can be enhanced by illuminating the individual grating with a single beam of light without affecting neighbouring gratings; in this example the spacing between gratings is 2 degrees, the spatial frequency is 500 lines/mm and the recording wavelength is 532 nm;

FIG. 6 is a schematic of writing multiplexed data by enhancing seed gratings in a reflection format. The single beam enhancement process pushes the diffraction efficiency of an individual grating above a threshold level;

FIG. 7 is a schematic of reading the multiplexed data in a reflection format. A signal above threshold level is obtained for the gratings that have been ‘enhanced’;

FIG. 8 is a schematic of writing multiplexed data by enhancing seed gratings in a transmission format. The reconstructed beam (and therefore signal strength) is greater after single beam illumination;

FIG. 9 shows a schematic of a single beam recording and readout of a single page of data or an image. (A) illustrates that a photopolymer layer containing a pre-recorded weak grating produces a weak uniform beam in the first diffracted order of the reading beam; (B) illustrates that a spatial light modulator in the writing beam allows the diffraction efficiency to be enhanced only in some pixels; and (C) illustrates that the reading beam will re-create the pattern in the first order diffracted beam when the spatial light modulator has been removed;

FIG. 10 is a schematic of the optical set-up actually used to record a page of data with a single recording beam and a seed grating. (A) shows the two beam set-up used to record the seed grating, using one converging and one collimated beam; (B) shows the optical set-up used to record a page of data/image on an SLM into the recording medium in which 1 is a special filtered collimated beam; 2 is a beam splitter; 3 is a mirror; 4 is a polarizer; 5 is a Spatial Light Modulator (SLM); 6 is a polarizer; 7 is a lens; 8 is a pinhole; and 9 is a photopolymer. The data can then be replayed by illumination with a collimated beam. The output is shown in FIG. 11;

FIG. 11 is a photograph of a page of data recorded using single beam recording using a seed grating. The setup used is shown in the FIG. 10;

FIG. 12 (A) is a plot showing the recording of a diffraction grating using standard two-beam interference without any disturbance; (B) and (C) are plots showing the recordings of a diffraction grating using standard two beam interference in an unstable environment; (D) is a plot showing short two beam recording to create a seed grating followed (after 30 seconds delay) by single beam enhancement of a diffraction grating in a stable environment; (E) and (F) are plots showing short two beam recordings to create a seed grating followed (after 30 seconds delay) by single-beam enhancement of a diffraction grating in an unstable environment (arrows show points at which optical table was struck);

FIG. 13 (A) is a graph showing multiplexing of three gratings (upper curve) created using on-Bragg enhancement of seed gratings (lower curve) the angular separation between each grating was 2 degrees; (B) is a graph showing three multiplexed gratings (upper curve) created using on-Bragg enhancement of seed gratings (lower curve) the angular separation between each grating was 1.5 degrees; (C) is a graph showing three multiplexed gratings (upper curve) created using on-Bragg enhancement of seed gratings (lower curve) the angular separation between each grating was 1 degree; (D) is a graph showing two overlapped Bragg curves allowing the comparison of the signal read out from gratings formed by the one beam and two beam processes. The upper curve (two-beam) is the read-out from a grating created with the regular two-beam holographic process and the lower curve (one beam) is the signal read from a grating created with the single beam process; and (E) is a graph showing diffraction efficiency versus reading beam angle of incidence for a series of seed gratings in which one (the second from the left) has been ‘enhanced’ using a single on-Bragg writing beam. The graph shows what happens to neighbouring gratings with a grating separation of 1.5° when one grating is illuminated on Bragg. The diffraction efficiency of the neighbouring grating is observed to increase somewhat in addition. In this case the recording wavelength was 532 nm and the spatial frequency was 500 lines/mm in a 130 micron thick layer;

FIGS. 14 (A) and (B) are graphs showing post-exposure with short light source (LED) for gratings with an initial exposure (IE) of 3 sec and a post exposure (PE) of 60 sec (A) and gratings with an initial exposure (IE) of 2 sec and a post exposure (PE) of 120 sec (B). These graphs demonstrate that enhancement can be performed with low coherence sources; and

FIG. 15 is a photograph of a reflection grating created with the single beam process. The circle indicates the area where the reflection seed grating was recorded. The lower half of the seed grating area (the portion below the dashed line) was then exposed to a single beam of collimated light. The lower half of the circular area (the portion below the dashed line) shows green light being diffracted towards the camera demonstrating that the illuminated portion of the seed grating was successfully enhanced. The lack of diffraction from the upper half of the circle (the portion above the dashed line) shows that the unilluminated portion of the seed grating is unchanged.

### DETAILED DESCRIPTION

In one aspect, the invention provides a method for enhancing the diffraction efficiency of a pre-recorded weak holographic grating or hologram. In a further aspect, the invention provides a method for creating a new grating hologram in close proximity to a pre-recorded weak holographic grating or hologram. In both cases, the pre-recorded weak holographic grating or hologram is illuminated with a single beam. In the case of enhancing the diffraction efficiency the diffraction efficiency of a pre-recorded weak holographic grating or hologram, the content recording step is a single beam enhancement process which raises the diffraction efficiency of a pre-recorded grating or hologram, instead of the usual two beam holographic recording. In the case of forming a new grating or hologram in close proximity to the pre-recorded grating or hologram, the content recording step is a single beam illumination of a pre-recorded grating or hologram. Advantageously, the content recording process only requires one recording beam and interferometric stability is not necessary. This simplifies the content recording process as there is no need to record a holographic grating for each bit of content to be stored. Therefore, problems associated with trying to perform two-beam holographic recording in a compact content storage system, for example beam manipulation problems and stability problems, are avoided whilst retaining the advantages associated with holographic data storage. The invention provides for one beam holographic content storage with angular multiplexing capability and simple one beam data writing into or in close proximity to pre-recorded holographic gratings such as security holograms.

In a further aspect, the invention relates to single beam on-Bragg enhancement of the refractive index modulation in self-developing holographic recording materials. Low efficiency ‘seed gratings’ can be pre-recorded in the storage medium, with multiplexing, high density, multilayer storage and all the other advantages of holographic recording, but a simple one-beam system is all that is required at the content recording stage. The diffraction efficiency of a pre-recorded holographic grating can be increased by illumination with just one recording beam or a new grating can be created in close proximity to a pre-recorded grating by illuminating the pre-recorded grating with a single recording beam. The recording beam may be one of the beams used to Pre-record the initial low efficiency grating or hologram in the storage medium or it may be any other type of beam with suitable wavelength and angle of incidence. The recording method provides content storage without the challenges normally associated with on-the-spot holographic recording such as low tolerance of vibration in the environment.

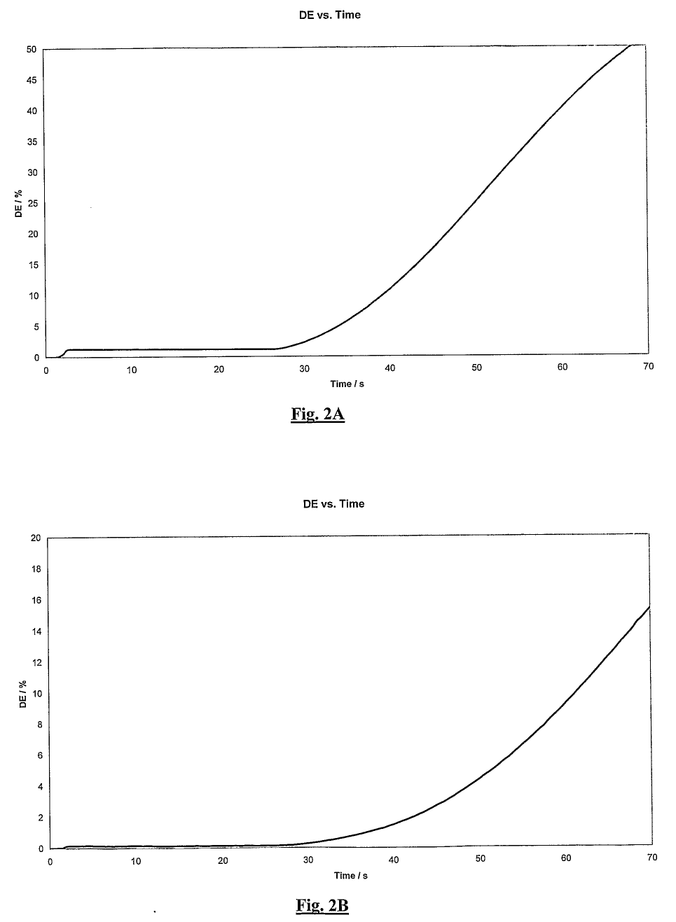

FIG. 2A shows a 500 lines/mm recording in which a standard two-beam recording of 2 s duration, of a grating is followed by a 25 s delay, and then single beam exposure starts at 27 s. The diffraction efficiency is observed to increase by a factor of at least 40 over the original diffraction efficiency.

FIG. 2B shows a layer thickness of 183.3 μm in which a standard two-beam recording of 2 s duration of a grating is followed by a 25 s delay, and then single beam exposure starts at 27 s for a period of 45 s. The diffraction efficiency after initial exposure was 0.14%, whereas the diffraction efficiency after post exposure was 15.3%. The difference in diffraction efficiency achieved corresponds to over a 100 fold increase in diffraction efficiency. Referring to FIG. 2B, an increase in diffraction efficiency of 109.3 times was achieved. This demonstrates the large diffraction efficiency increases which can be obtained by exposing a pre-recorded grating to a single beam using the methods described herein.

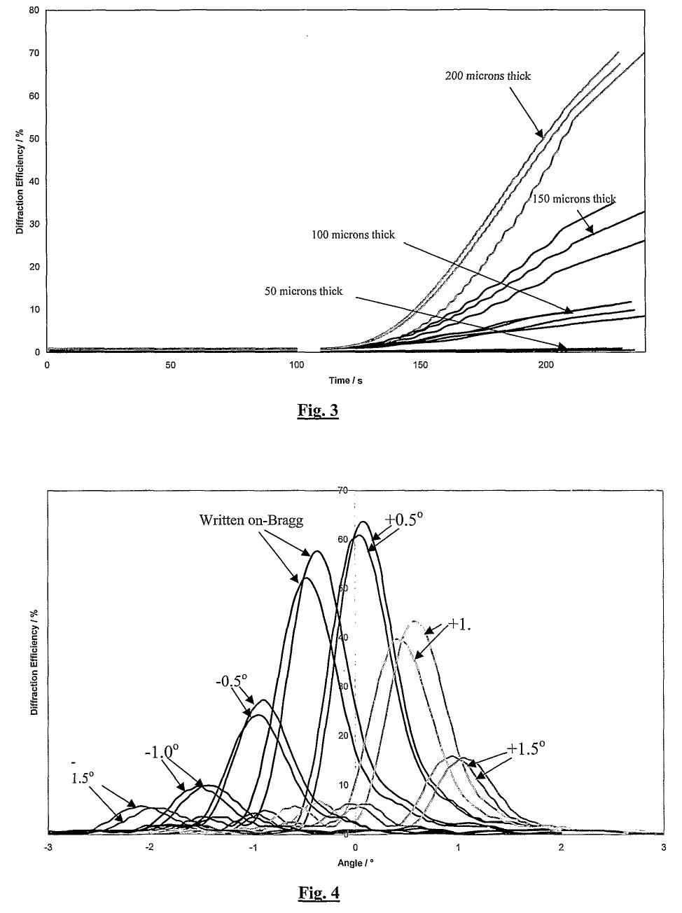

Storage material ranging in thickness from about 1 micron to above 1 mm has been fabricated. We have found that the single beam recording process described herein is more efficient at greater thickness of storage material. Referring to FIG. 3, which illustrates the diffraction efficiency of layers ranging from 50 microns to 200 microns thick, it can be seen that the thicker the storage material, the greater the diffraction efficiency of the final grating. Lower spatial frequencies and greater layer thicknesses are likely to lead to even larger increases in diffraction efficiency. An increase of eighty times the efficiency of the seed grating has been observed. The growth of the diffracted beam under single beam exposure conditions is shown in FIG. 3 (thickest sample layer).

If a pre-recorded grating is illuminated with a beam of light which is slightly off-Bragg, the Bragg curve of the final grating is shifted in the direction of the offset. This effect could be used to reduce the number of seed gratings needed by allowing for several ‘data’ gratings to be formed from one pre-recorded low efficiency seed grating. This effect could also be used to choose the angular position of the new grating (created in close proximity to the pre-recorded grating by single beam illumination of a pre-recorded grating) by altering the angle of the single recording beam relative to the Bragg angle for the pre-recorded grating, for an additional dimension of information (content) recording or in order to create specific diffraction effects in the final hologram. This additional flexibility would increase the content storage capacity of the material to a level comparable to data storage using two beams or may allow for greater tolerances in alignment for single beam writing processes which may facilitate cheaper and simpler recording systems.

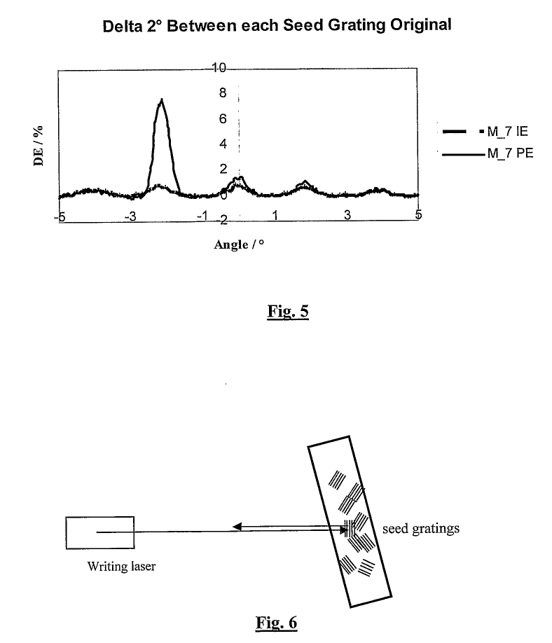

FIG. 4 illustrates a series of gratings that are ‘read’ near their optimum coupling angle or Bragg angle as described above. The gratings were formed using single beam exposure of pre-recorded ‘seed’ gratings whose original diffraction efficiencies were close to 1.3%. However, in each case the single exposing beam used to increase the diffraction efficiency of the seed grating had a slight angular offset from the original writing angle. The resulting gratings have Bragg curves shifted in the direction of the offset. This could indicate a small tilt in the grating fringes in that direction. As might be expected, the ultimate diffraction efficiency is less under the same exposure conditions when the illuminating beam is not precisely on—Bragg. This is most likely due to the reduced coupling between the single writing beam and the pre-recorded ‘seed’ grating. At a thickness of 135 microns, spatial frequency 500 lines/mm and wavelength 532 nm, an offset of more than 1.5 degrees causes very little increase in the diffraction efficiency of the seed grating. At high spatial frequency and larger thickness the permitted offset angle may be smaller due to the increased selectivity. This is important for the minimization of crosstalk and will ultimately determine the number of seed gratings that can be angularly multiplexed into the material. It may also be possible to record a number of enhanced gratings using the same seed grating, and still resolve them as separate data ‘bits’. This could mean that a material used in this way would have an M number or storage capacity that is comparable with or not significantly lower than the M number or storage capacity that the material has when used in normal two beam holographic data storage.

In accordance with Kogelnik's theory, the width of the Bragg curve is lower for greater thickness and for higher spatial frequencies. The graph of FIG. 4 gives an example of the relative angular widths. Much narrower peaks (and consequently closer spacing) could be achieved for the thicker samples and higher spatial frequencies typically used in content storage.

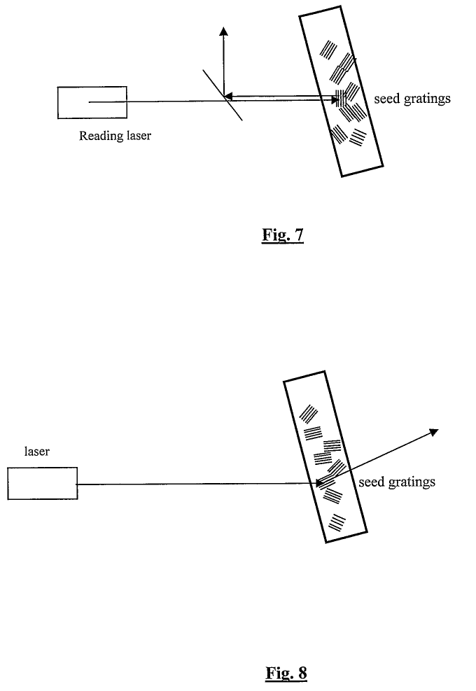

FIG. 5 shows diffraction efficiency plotted against illumination angle as the data reading beam scans a range of angles where a series of multiplexed ‘seed’ gratings have been recorded. One of the gratings has been ‘enhanced’ without enhancing its neighbours.

The low efficiency ‘seed’ gratings were recorded using a 532 laser while the photopolymer recording medium was rotated by 2 degrees between recordings. One seed grating was then ‘enhanced’ by illuminating it with a single beam at the Bragg angle appropriate for that grating. A reading laser scans the medium through a range of angles and the output in the diffracted beam is read with a photodetector so that the diffraction efficiency of each grating is measured. Referring to FIG. 5, the individually enhanced grating (m−7 pe) shows an increased diffraction efficiency. This demonstrates, to our knowledge for the first time, that it is possible to use a single beam of light to significantly increase the diffraction efficiency of an individual low efficiency grating without affecting the diffraction efficiency of neighbouring gratings in a series of gratings.

Photopolymer recording materials, such as those of Aprilis and Inphase Technologies, have been researched extensively in the USA, as photopolymers are regarded as the best candidates for ‘Write Once Read Many’ optical data storage. The main disadvantage of most currently available photopolymers is that they suffer from post recording shrinkage. The photopolymer material used herein (for the formulation, see I. Naydenova, H. Sherif, S. Mintova, S. Martin, V. Toal, “Holographic recording in nanoparticle-doped photopolymer”, SPIE proceedings of the International Conference on Holography, Optical Recording and Processing of Information, V 6252, 45-50, 2006) can be characterised by relatively low shrinkage, as recent improvements to the material have allowed us to reduce it to 0.1% for 650 μm layers. However the single beam content storage methods described herein may also work well in other suitable materials.

The invention will be more clearly understood from the following examples.

### Example 1

### Data Storage Bit Wise Worm

In this first example the data is recorded as ‘bits’ of information in the same way that a bit-wise holographic data storage system works. Each grating represents one bit of information and either the relative diffraction efficiency, or the absence or presence of a grating (and therefore of a signal at readout) indicates a 1 or a 0 bit. Since the material, is not re-writable it is a Write Once Read Many system like writable (write once) CDs, most suitable for archiving purposes.

In this example, a set number of weak gratings are pre-recorded in the data storage medium, so that they can be selectively enhanced (or not) according to whether a 1 or a 0 bit is to be recorded.

Retrieval of the information is carried out in a manner identical to the procedure for retrieval in standard holographic data storage systems. A reading beam of a wavelength to which the medium is insensitive can be used to probe the gratings, or alternatively a low intensity version of the writing beam can be used, especially if a UV or white light fixing step is used to render the material insensitive to further exposure.

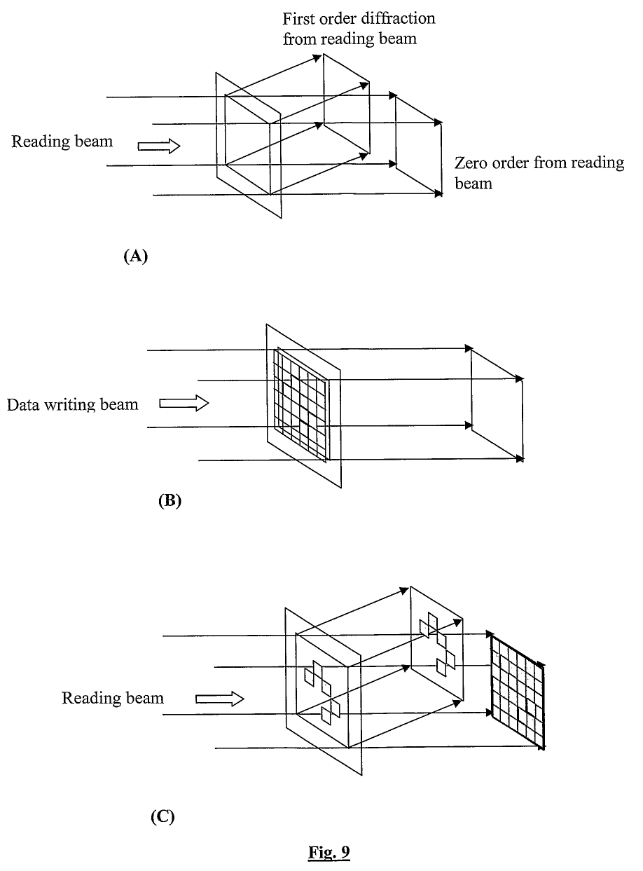

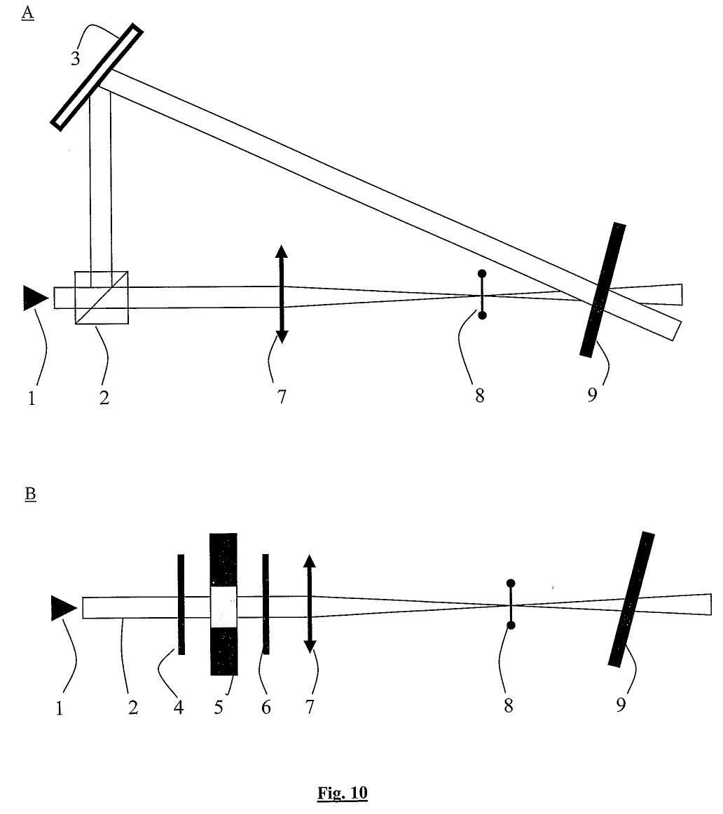

FIG. 6 shows a schematic of a system to enhance weak (seed) gratings recorded in the medium. In some content storage applications this is the data writing step. In the schematic, the single writing beam is incident at the correct angle for on-Bragg illumination of one of the pre-recorded gratings. The efficiency of that grating will therefore increase, giving a stronger signal beam when the grating is later interrogated by the probe beam during data reading (FIG. 7).

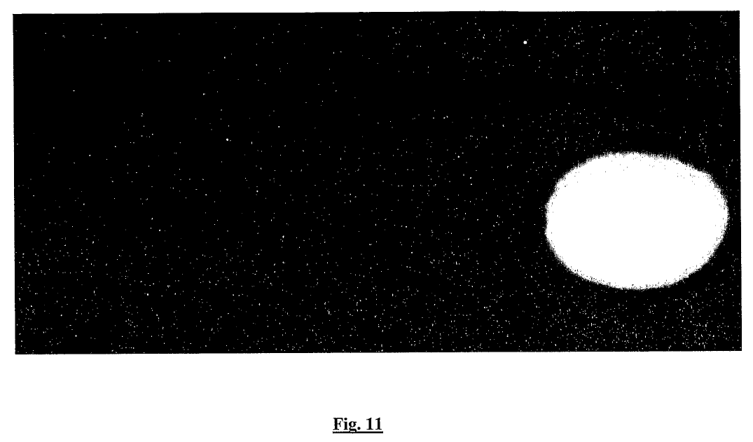

FIG. 8 shows a similar arrangement, but set up in a transmission grating geometry, where the signal beam would be transmitted through the medium.

### Example 2

### Image/Page Wise Data Storage

In the most straightforward single beam page recording system a two-dimensional pattern is used as a mask over the writing beam (in this case an expanded collimated beam is used) using for example a spatial light modulator. A pre-recorded grating could be preferentially enhanced by the high intensity pixels and the resulting diffraction efficiencies will be proportional to the intensity in the original image (the grating would have to be at least as large in area as the image). This will allow extraction of the image at a later date.

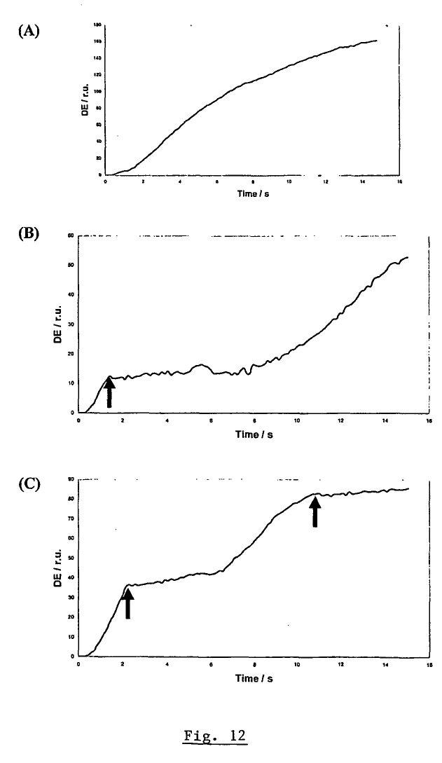

In the collimated system, either the mask would have to be in near contact with the photosensitive medium or the image would have to be projected in such a way that a collimated on-Bragg beam of spatially varying intensity was incident on the photosensitive medium for example using a telecentric lens. FIG. 9 shows a schematic of a single beam recording and readout of a single page of data or image. The same possibilities for multiplexing exist in this format too. The collimated light passes through in SLM which, through altering the percentage transmission at different pixels, can control the degree of enhancement in different areas in the recording medium. This allows a patterned ‘enhancement’ of the seed grating leading to the recording of a page of data that can be reconstructed in the first order diffracted beam.

Alternatively the recording setup can also use a converging or diverging beam of light.

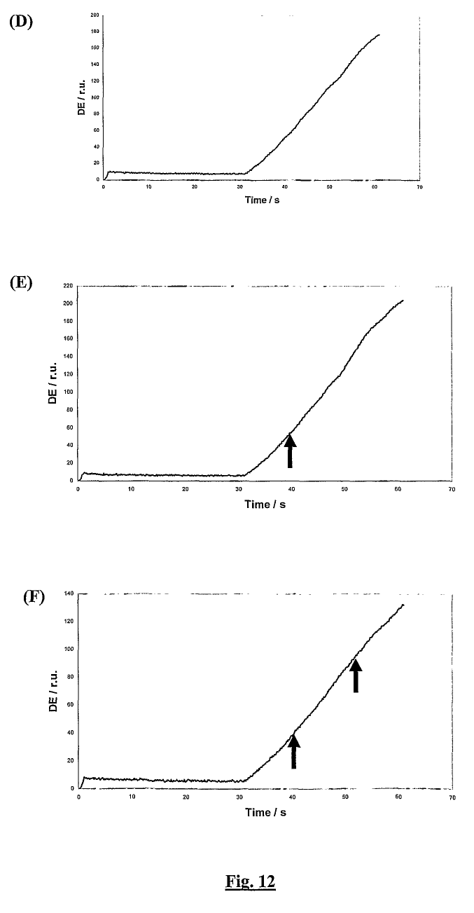

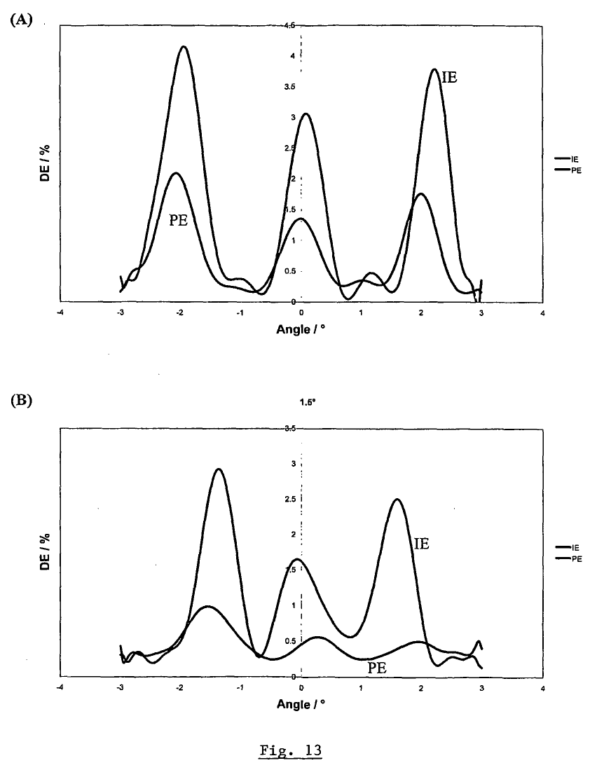

FIG. 10 shows the recording setup used to obtain the recording of the image or page of data with a single recording beam and a seed grating. FIG. 10 (A) shows the two beam set-up used to record the seed grating, which in this case was done with one converging and one collimated beam. FIG. 10 (B) shows the optical set-up used to record a page of data/image on an SLM into the recording medium. The data was then replayed by illumination with a collimated beam. The result is shown in FIG. 11. FIG. 11 is a photograph of a reconstructed image of a data page of a checker board pattern. The data page was recorded with the set-up shown in FIG. 10 and reconstructed using a collimated beam of light. The reconstructed checkerboard pattern is seen on the left and the undiffracted light in the zero order is seen on the right. This shows, for the first time, that a two dimensional page of data can be recorded as holographic gratings using just one beam of incident light and afterwards ‘read’ using a reading beam in the same way as in regular holographic data storage.

### Example 3

### Data Writing in Unstable Conditions and with Low Coherence

An important advantage of the single beam system is the fact that the second beam needed to produce an interference pattern is produced within the pre-recorded grating inside the recording material. This means that vibrations and disturbances that would normally disturb an interference pattern by causing one part of the optical system to move relative to another do not affect the interference pattern in this case. Equally the very short path difference (less than the thickness of the grating) means that very short coherence length can be tolerated in the light source while still obtaining a high contract interference pattern.

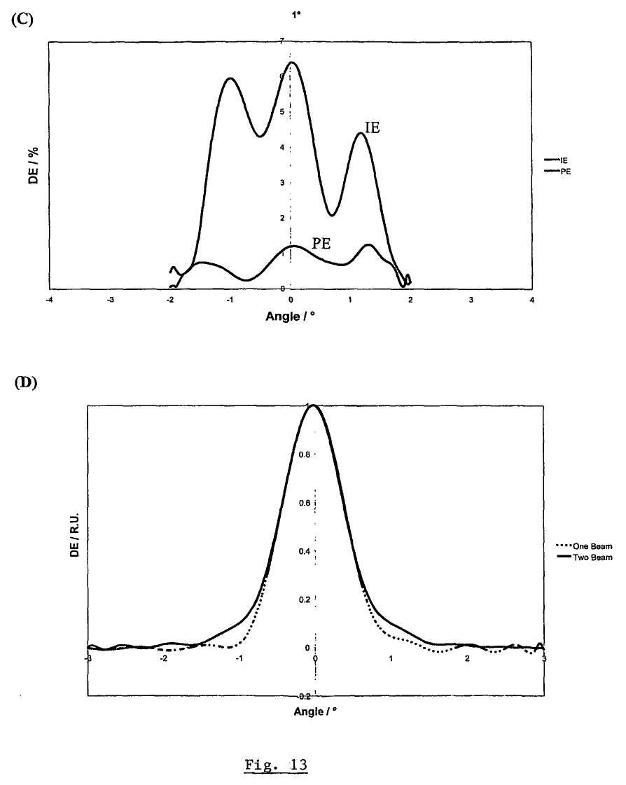

In regular two-beam recording the diffraction efficiency increases as the recording progresses (FIG. 12(A)). As expected the curve is smooth, indicating a steady growth in the refractive index modulation of the grating and indicating that the interference pattern remained stable throughout the recording. It is well known that due to the micron and sub-micron widths of typical holographic interference fringes in such gratings, even sub-micron environmental vibrations and instabilities cause a ‘blurring’ of the interference fringes that is catastrophic for the formation of the grating/hologram. Vibration isolated optical tables and controlled noise and airflow are routinely used in holographic recording in order to minimize the disturbances that would be detrimental to grating growth.

If a disturbance is deliberately introduced, however, the growth of diffraction efficiency is disturbed (FIGS. 12(B) and (C)). In the graphs the arrow indicates the point at which the vibration isolated optical table was deliberately struck in order to introduce vibration and instability in the setup.

We then compare this to the situation while single beam recording is carried out: FIG. 12(D) shows the normal growth of diffraction efficiency with time for single-beam exposure of a weak seed grating under normal stable recording conditions. The conditions are identical to, those in FIG. 12(A) and as expected the growth curve is again smooth.

In FIGS. 12(E) and (F) a disturbance is again introduced by striking the table during recording. However, in contrast to the situation with two-beam recording, the use of the single beam recording approach means that even in the presence of vibration and instability in the setup the grating grows steadily. The growth curves in FIGS. 5 and 6 are unaffected by the environmental instability.

These results demonstrated that one-beam recording works well in unstable conditions.

As an indication of the decrease in packing density that may occur for the use of simple one beam writing of data in comparison with regular two beam writing, we have studied the Bragg curves of neighbouring gratings produced by the one beam and two beam systems with decreasing angular separation between the neighbouring peaks. This allows us to estimate, how close together the gratings can be recorded while still being resolvable during the reading process so that a comparison can be made between the two beam and one beam systems.

In normal two-beam recording there is a limit to how close to one another (in angular terms) two gratings can be recorded before the two peaks become impossible to resolve during the reading process. Because it depends primarily on the width of the peak, the minimum angular separation needed in order to be able to resolve the gratings is a function of grating thickness, wavelength and the spatial frequency of the grating.

In single beam recording, there are two potential limiting factors. One is that, as in two beam recording, there is a limit to how close to one another (in angular terms) two gratings can be recorded before the two peaks become impossible to resolve during the reading process. The second is that there is a minimum angular separation needed between the seed gratings to avoid the situation where (during the data writing step) enhancement of one causes an unacceptable increase in the efficiency of its nearest neighbour, rendering it indistinguishable from the enhanced grating.

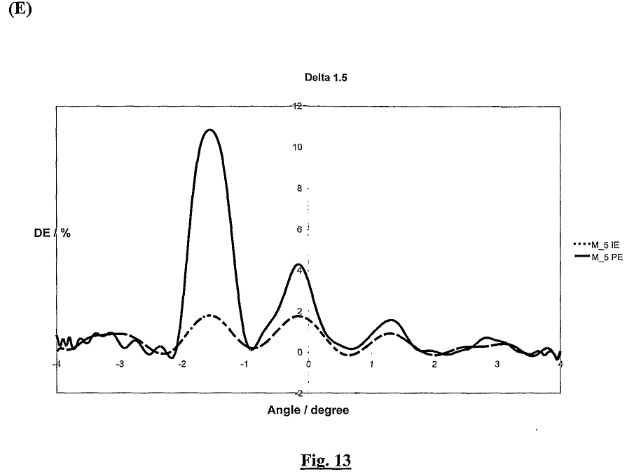

FIGS. 13 (A) to (C) show the Bragg curves of seed gratings together with the Bragg curves of the gratings obtained when these seed gratings have been enhanced by a single on-Bragg beam. The angular separation between the gratings is 2.0° 1.5° and 1.0° respectively and each grating has been ‘enhanced’. In FIG. 13(C) it is clear that overlap is beginning to be a problem in the cases of both the two beam recorded seed grating and the enhanced grating. It is interesting to note that the gratings created with the one beam process are not broader than those created with the two beam process. FIG. 13(D) shows two overlapped Bragg curves allowing the comparison of the signal read from gratings formed by the one beam and two beam processes. The upper curve (two-beam) is the read-out from a grating created with the regular two-beam holographic process and the lower curve (one beam) is the signal read from a grating created with the single beam process. The similarity of the width of the curves indicates that the resolution challenges associated with the reading of multiplexed gratings would be similar for both systems.

As explained above, the selectivity of the writing process is also important as there is a possibility of affecting the efficiency of the neighbouring gratings that are multiplexed at angles close to the grating being enhanced. FIG. 13(E) shows the effect that occurs when we enhance a seed grating that has a neighbouring seed grating angularly separated from it by 1.5°. There is an increase in the diffraction efficiency of the neighbouring grating. This will place a limit on the proximity of seed gratings in a system depending on the signal to noise ratio required in the read-out. In this example the thickness is 130 microns and the wavelength 523 nm in a 500 lines/mmm grating. In a HDS system the grating thickness would be greater and the spatial frequency much higher which would increase the angular selectivity, making the separation necessary for resolution much lower. However, we expect a similar relationship between the angular separation needed in two beam recording and that needed in one beam recordings. These measurements serve as a demonstration and a comparison of one beam and two beam technology.

Another advantage of the one-beam data writing system is the capacity to use low coherence light sources to enhance existing seed gratings:

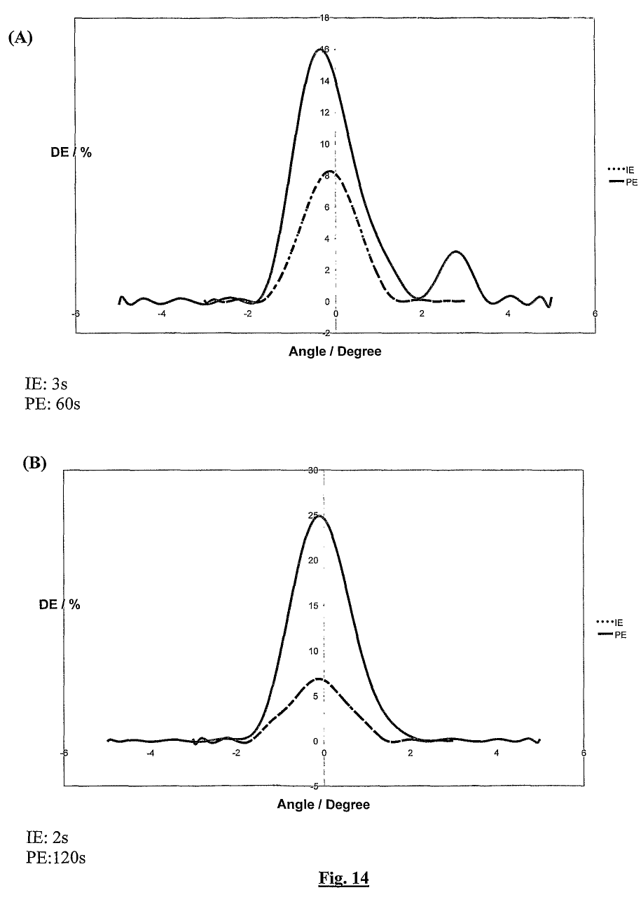

FIG. 14 shows the Bragg curve for a grating that has been created by the single beam enhancement of a seed grating where the beam used to enhance was from an LED for which the spectrum peak position is 524.29 nm and the coherence length is: 80.10 um. In FIG. 14(A) the seed grating has been exposed to a single beam from the LED for 60 seconds, in FIG. 14(B) it was 120 seconds.

This, demonstrates that the coherence length of the source can be as low as 80 microns and the diffraction efficiency is still raised significantly under single beam exposure. This may be because the reference beam that interferes with the incident beam is created within the photopolymer layer, so that there is a very short path difference between the two interfering beams.

### Example 4

### Single Beam Writable Security Holograms

The one-beam holographic recording approach allows the diffraction efficiency of a pre-recorded grating to be increased significantly by subsequent exposure to a single recording beam incident at or near the Bragg angle. Since text and images that are visible by eye can be added later by using a single beam of light there are applications in security hologram production and individualised display holography

The recording setup is envisaged to be so simple for the type of content storage described above that it would be possible to utilize a simple version in security holography. There are many reasons why it would be advantageous to be able to combine limited low cost data storage with security holography, not least of which is the growth in interest in storage of biodata, encryption keys, and other security measures.

The technology described here could provide a method of allowing an end user, say at a passport office, bank, or similar, to individualise the security hologram without having to perform two beam holographic recording in order to record unique data. This would allow a cheap one beam system to be built which could have a low coherence source and not be susceptible to vibrations and mechanical disturbance.

The standard overt and covert holographic security measures could be recorded by the manufacturing company while also preparing a section of the hologram which may contain seed gratings suitable for the subsequent recording of content. The complexity of such content pre-recorded could range from a simple text mask to allow recording of a person's name and/or photograph etc as a visually readable part of the hologram, to the covert recording of biodata or complex encryption key data in a section of the security hologram. The single beam recordings added by the end user could equally be in the form of holographic diffraction gratings at a range of angle and positions, (for example suitable for reading by a scanner) The techniques described herein provide the capability for an end user to form new gratings off-Bragg by altering the angle of incidence of the writing beam, or even limited three dimensional images created using a series of seed gratings that overlap or nearly overlap in area and angular spread.

We envisage that the one-beam recording approach could be used to devise a very simple hologram writing system for use in security applications, product tracking, and display holography.

Using a one-beam text and image ‘writer’ consisting of some very simple optical components and a diode laser, the user can write personal information such as date of birth, fingerprints, individualized product information such as barcodes or serial numbers and/or photographs and images into an existing security hologram.

Identical security holograms could be mass-produced in photopolymer bearing a logo and other generic information, with a section left ‘blank’ for recording of information by the end user (passport office, bank etc). The ‘blank’ section may contain weak pre-recorded seed gratings whose diffraction efficiencies can be increased or new gratings could be formed in close proximity to the pre-recorded grating by exposure of a pre-recorded grating to a single laser beam, if desired, thereby allowing text and images to be added into the hologram without the need for normal two beam holographic recording. This could allow customized text and images to be written onto security holograms without the interferometric stability and coherence problems normally associated with holographic recording.

This is distinct from content storage because in this case visual text and images are written to the recording medium. Text and images are intended, to be read by eye (visible by eye), as holographic images, just as in a regular hologram.

The advantage for security is that forgery would become almost impossible especially if other features of security holography were used. An additional advantage would be the ease with which holographic microtext/logos could be added by the end user, with for example, the date of issue- and company logo easily being incorporated into the text to be recorded.

The advantages of this approach include the vibration tolerance of the technique; the lack of a reference beam removes the need for interferometric stability and means that a ‘writer’ system could be produced cheaply for use in normal desk top environments. Inexpensive liquid crystal screens, masks and/or simple laser scanning could be used to create text or images in the hologram.

An additional advantage is the fact that the medium can also carry regular holographic images and text; for additional security, microtext and other covert holographic security features can be included in the mass-produced hologram and/or the images and text added with the single beam ‘writer’.

### Example 5

### Use of Seed Gratings in the Mass Production of Holograms

We have shown that a grating can be recorded with two beams until the diffraction efficiency is just one percent or lower and it will still respond to a single beam incident at the Bragg angle by increasing in diffraction efficiency until the diffraction efficiency is 70% or higher, thus the system described herein is suitable for application in the mass production of low cost holograms.

In high volume production such as security holograms on packaging, a key cost is the amount of time required to expose each hologram to an expensive high coherence laser in an interferometrically stable environment in order to create the image. In our system the time spend on this step would be minimised by including a further step using cheap low coherence light sources that would increase the efficiency of the grating and/or superimpose text and images at a later stage of the production process. This could, of course also include the ability to individualize holograms, described in Example 3 and 4 above, for security and product tracing purposes. The processes are easily adapted to in-line mass production processes.

Recording of limited three dimensional holographic images may also be possible within the Bragg envelope of the seed grating or gratings, as, referring to FIG. 4, it can be seen that completely new gratings can be formed at a range of angles depending on the angle of the incident single beam

### Example 6

### Single Beam Enhancement of a Reflection Hologram

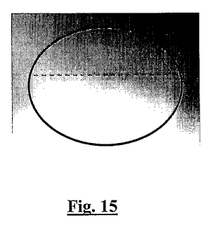

For security and visual display applications the recording must be performed in a reflection format. FIG. 15 is a photograph of a reflection grating created with the single beam process. The circle indicates the area where the reflection seed grating was recorded. The lower half of the seed grating was then exposed to a single beam of collimated light. The lower half of the circular area indicated shows green light being diffracted towards the camera demonstrating that the illuminated portion of the seed grating was successfully enhanced. The lack of diffraction from the upper half of the circle shows that the unilluminated portion of the seed grating is unchanged.

The invention is not limited to the embodiment hereinbefore described, with reference to accompanying drawings, which may be varied in construction and detail.

1-57. (canceled)

58. A method of recording content comprising the steps of:
providing a content storage medium comprising a pre-recorded grating or hologram; and
illuminating a pre-recorded grating or hologram with a single recording beam to record content in the grating or hologram

59. The method as claimed in claim 58 wherein the recording beam increases the diffraction efficiency of the pre-recorded grating or hologram.

60. The method as claimed in claim 59 wherein the recording beam increases the diffraction efficiency of the pre-recorded grating or hologram by at least 40-fold, by at least 100-fold.

61. The method as claimed in claim 59 wherein the single recording beam is an on-Bragg beam, or the single recording beam is off-Bragg, the single recording beam may be within the Bragg envelope.

62. The method as claimed in claim 61 wherein the multiple gratings or holograms are recorded using the same pre-recorded grating by varying the off-Bragg angle of the recording beam during content recording.

63. The method as claimed in claim 58 wherein the content is recorded by forming a new grating or hologram in close proximity to a pre-recorded grating or hologram.

64. The method as claimed in claim 63 wherein the single beam is an off-Bragg beam, the single beam may be within the Bragg envelope.

65. The method as claimed in claim 64 wherein multiple gratings or holograms are recorded using the same pre-recorded grating by varying the off-Bragg angle of the recording beam during content recording.

66. The method as claimed in claim 58 wherein the content storage medium comprises a self developing holographic recording medium, the pre-recorded grating or hologram may be recorded in the self developing holographic recording medium, the pre-recorded grating or hologram may be recorded in the self developing holographic recording medium using two recording beams.

67. The method as claimed in claim 58 wherein the pre-recorded grating or hologram has a spatial frequency of up to 7,000 lines per mm, up to 6,300 lines per mm, between 2,500 to 6,300 lines per mm, between 1,000 to 2,500 lines per mm, between 500 to 1,000 lines per mm, between 100 to 500 lines per mm, or between 1 to 100 lines per mm.

68. The method as claimed in claim 58 wherein the storage medium comprises a plurality of pre-recorded gratings or holograms.

69. A use of a self-developing holographic recording medium containing a pre-recorded grating or hologram for the storage of content.

70. The use as claimed in claim 69 wherein the content is data, an image, is visible by eye, and/or is stored by enhancing a pre-recorded grating or hologram, the diffraction efficiency of a pre-recorded grating or hologram may be increased by illumination of the pre-recorded grating or hologram with a single beam.

71. The use as claimed in claim 70 wherein the single beam is an on-Bragg beam, is an off-Bragg beam, and/or is in the Bragg envelope.

72. The use as claimed in claim 69 wherein the content is stored by forming a new grating or hologram in close proximity to a pre-recorded grating or hologram, the pre-recorded grating or hologram may be illuminated with a single beam, the single beam may be an off-Bragg beam, and/or the single beam is in the Bragg envelope.

73. The use as claimed in claim 69 wherein the recording medium has a thickness of between 1 μm and 1 mm.

74. The use as claimed in claim 69 wherein the recording medium comprises a plurality of pre-recorded gratings or holograms, the recorded gratings or holograms may be multiplexed, holograms or gratings may be multiplexed in the medium.

75. Use as claimed in claim 69 wherein the pre-recorded grating or hologram comprises a reflection grating or hologram, and/or a transmission grating or hologram.

76. The use as claimed in claim 69 wherein the holographic recording medium is write once, read many times, the holographic recording medium may contain a security hologram.

77. A content storage medium comprising a self developing holographic recording medium containing a pre-recorded grating or hologram.

78. The storage medium as claimed in claim 77 wherein the recording medium has a thickness of between 0.1 μm and 5 mm, between 0.1 μm and 2.5 mm, between 0.1 μm and 1 mm.

79. The storage medium as claimed in claim 77 wherein the recording medium contains a plurality of pre-recorded gratings or holograms, the pre-recorded gratings or holograms may be multiplexed, the pre-recorded holograms or gratings may be multiplexed in the medium, the grating or hologram may comprise a reflection grating or hologram and/or a transmission grating or hologram, the storage medium may be write once, read many times, the storage medium may contain a security hologram.
